(19) United States
(12) Patent Application Publication
(10) Pub. No.: US 2005/0099451 A1
(43) Pub. Date: May 12, 2005

(54) Method and apparatus for reducing debris accumulation in an ink jet printhead

(75) Inventors: Kevin Kuester, Freeburg, IL (US); Jack Heller, Glendale, MO (US); John R. Wall, Fairview Heights, IL (US)

Correspondence Address: MCANDREWS HELD & MALLOY, LTD, 500 WEST MADISON STREET, SUITE 3400, CHICAGO, IL, 60661, US

(73) Assignee: Videojet Technologies Inc.

(21) Appl. No.: 10/979,888

(22) Filed: Nov. 2, 2004

Related U.S. Application Data
(60) Provisional application No. 60/517,268, filed on Nov. 4, 2003.

(51) Int. Cl. B41J 2/165

(52) U.S. Cl. 347/25

(57) ABSTRACT

An inkjet printhead includes a housing defining an interior compartment. The housing includes a front or print face which presents an array of nozzles that are adapted to project drops of ink on a substrate as the substrate passes in front of the array. The front face defines a front air passage that surrounds at least a portion of the nozzle array to allow air flow between the exterior of the housing and the interior compartment. The housing defines at least one additional air passage constructed to allow air flow between the exterior of the housing and the interior compartment. The air passages are constructed to create positive air flow through the front passage which reduces the accumulation of debris around the orifice array. The printhead may also include a protective structure that extends across a portion of the front air passage to protect the orifice array from being damaged by materials, such as mail, that move past the printhead at high speeds during the printing operation.

### RELATED APPLICATIONS

This application claims the benefit of U.S. provisional patent application Ser. No. 60/517,268, which was filed on Nov. 4, 2004 and is hereby incorporated in its entirety by reference.

### BACKGROUND OF THE INVENTION

Drop-on-demand ink jet printers are commonly used, for example, for imprinting packages, boxes or mail conveyed along a conveyor line. Each printhead typically has a nozzle assembly with an array of orifices or ink outlet openings from which ink is expelled in the form of droplets. The droplets are expelled in a predetermined pattern toward a side of the carton or object (or other surface) to be imprinted such that upon the ink striking the carton surface, a predetermined indicia is imprinted on the surface. Such ink jet printing apparatus may be used, for example, to print a variety of information (indicia) on a carton or package, such as trademarks, lot numbers, serial numbers, production dates, shipping date information, bar codes, graphics, and other pertinent information. The nozzle assembly of the printhead is in communication with a supply of ink. A programmable controller regulates the operation of the valves or other well known means for forming and expelling the ink droplets so as to cause the ink to be emitted from the nozzle orifices according to a preselected pattern so as to imprint the desired information or indicia on the surface to be imprinted as the surface passes in front of the printhead.

The printhead typically consist of a housing that contains the nozzle assembly and the electronics for controlling operation of the nozzle assembly. Generally, the nozzle assembly includes an orifice array located on a front or print face of the printhead with this print face being spaced a short distance (referred to as the orifice-to-substrate distance or the standoff distance) from the surface to be imprinted.

These printheads often operate in the presence dust, debris and other contaminants that can adversely effect the performance of the printhead. For example, in postal applications, the relatively high line speed, coupled with frequent direction changes and bending of the mail pieces, creates a large amount of paper dust, loose fibers and general debris. This debris deposits on all surfaces of the printing equipment, including the orifice array. When debris builds up to a significant level on the array, the orifices can be blocked or misdirected, resulting in decreased printing capabilities. This problem can be accentuated as throw distance is decreased to accommodate increased throughput. Specifically, as the number of pieces marked per unit of time, increasers, the throw distance typically needs to be decreased. For example, in postal applications line speeds of 787 f/min with throughputs of 15 prints per second are encountered. In order to meet these parameters with a typical ink jet printhead, it may be necessary to reduce the throw distances to 0.02 inches or less. This relatively small distance between the mail pieces and the printhead can increase the accumulation of debris in the printhead, particularly on the print face and the orifice array. As a result, there is a need for a printhead which reduces debris accumulation on and around the orifice array of an ink jet printer.

### BRIEF SUMMARY OF THE INVENTION

An inkjet printhead comprises a housing having a front face carrying an array of orifices. The housing including a first air passage surrounding at least a portion of the orifice array. At least one other air passage is provided in the housing. For example, the housing may include opposed side walls, wherein each of wall includes at least one opening to permit air flow into and out of said housing. The air passages are constructed to facilitate air flow past the orifice array to reduce the accumulation of debris around the orifice array. The printhead may also comprise a means for collecting ink that flows into said housing through said front opening. The means may comprise an absorbent material positioned within the housing, adjacent the front opening.

A protective structure may be disposed across a portion of the first air passage to prevent damage to the orifice array. The orifices may be arranged in a linear array and the protective structure may comprise a linear member extending across said opening in a direction generally parallel to said orifice array. The protective structure may be integrally formed with the front face of the housing. Alternatively the protective structure may be formed separately from the housing and attached thereto, e.g. by fasteners. The protective structure may be located upstream of the orifice array and/or downstream of the array.

### BRIEF DESCRIPTION OF SEVERAL VIEWS OF THE DRAWINGS

FIG. 1 is perspective view of an ink jet printing apparatus that utilizes an inkjet printhead according to certain aspects of an embodiment of the present invention.

FIG. 2 is a perspective view of an inkjet printhead according to certain aspects of an embodiment of the present invention.

FIGS. 3A and 4 are perspective views showing the printhead of FIG. 2 installed in a printing apparatus.

FIG. 3B illustrates certain aspects of an alternative embodiment.

FIG. 5 is a front elevation view illustrating certain aspects of an ink-jet printhead according to an embodiment of the present invention.

FIG. 6 illustrates a removable protective structure according to certain aspects of an embodiment of the present invention.

FIG. 7 illustrates an alternative embodiment of a face plate according to certain aspects of an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

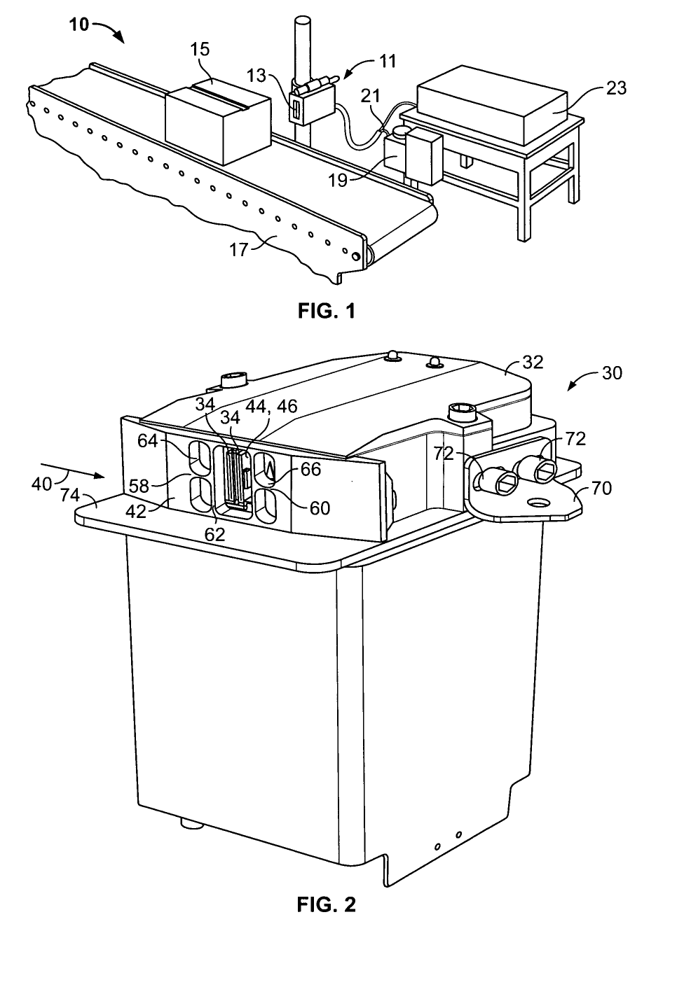

Referring now to drawings, FIG. 1 is a perspective view of an ink-jet printing station 10 positioned along a conveyor 17 which carries a series of articles, objects or other packages, generally indicated at 15, past the printing station. Each article or package has a surface upon which selected indicia are to be printed. Printing station 10 includes a printhead 11 mounted at a desired vertical height and horizontal spacing from the surface of article 15 such that indicia to be printed on the surface will have clear and sharp resolution on the surface. As will be appreciated, the printing station may include mounting or support structure for adjusting the position of the printhead 11 relative to the articles 15.

An ink supply system 19 is provided at printing station 10 so as to supply ink to the printhead through an ink supply line 21. A controller 23, as is well known in the art, is provided for controlling the flow of ink to the printhead 11 and for controlling operation of a nozzle assembly within the printhead to force ink from the orifices 13 of the nozzle assembly so as to form droplets in a predetermined pattern so as to imprint the desired indicia on surface 7 of the article 15. One such ink supply system and printhead are described in U.S. Pat. No. 5,101,224, which is hereby incorporated by reference. The printhead of the 224 patent utilizes nozzle assembly having a plurality of nozzles connected through individual valves to an ink source that is maintained under pressure. A programmable controller regulates the operation of the valves to cause ink to flow through the valves to the nozzles and to be emitted from the nozzles according to a pre-selected pattern or patterns. Alternatively, the nozzle assemblies may be piezoelectric printhead nozzles such as those disclosed in U.S. Pat. Nos. 5,227,813; 5,235,352; 5,426,455; 5,433,809; 5,436,648 and 5,703,631, the disclosures of which are herby incorporated by reference.

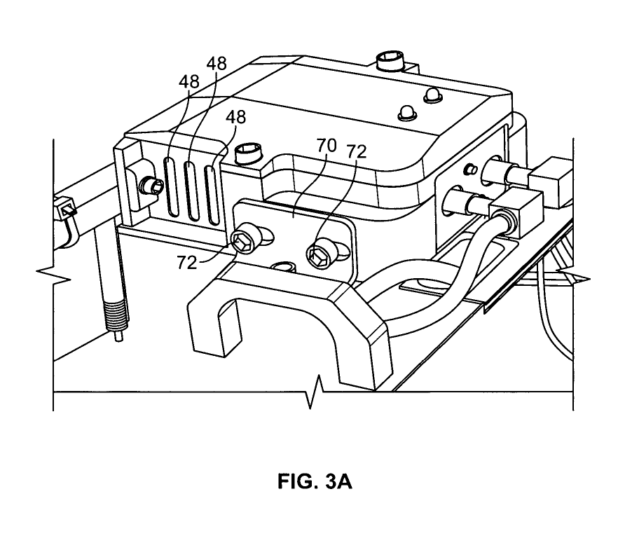

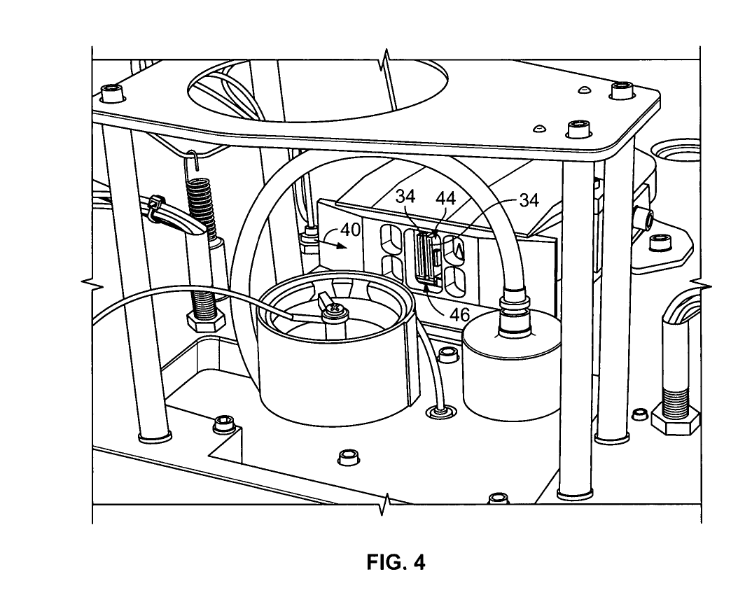

Referring now to FIG. 2-4, a printhead 30 according to certain aspects of the present invention is shown in greater detail. The printhead 30 comprises a housing 32 which defines an interior compartment (not shown). At least one nozzle assembly 34, as well as electronics (not shown) for controlling the nozzle assembly, are mounted within the interior compartment. In the illustrated embodiment the printhead includes two nozzle assemblies 34 (or print engines) arranged in a back-to-back configuration. While the printhead 30 is illustrated as having two nozzle assemblies, it will be appreciated that the printhead could have one or more nozzle assemblies without departing from the scope of the present invention. The nozzle assemblies 34 are connected to an ink supply (not shown) and to an external electronic controller (not shown) as described above.

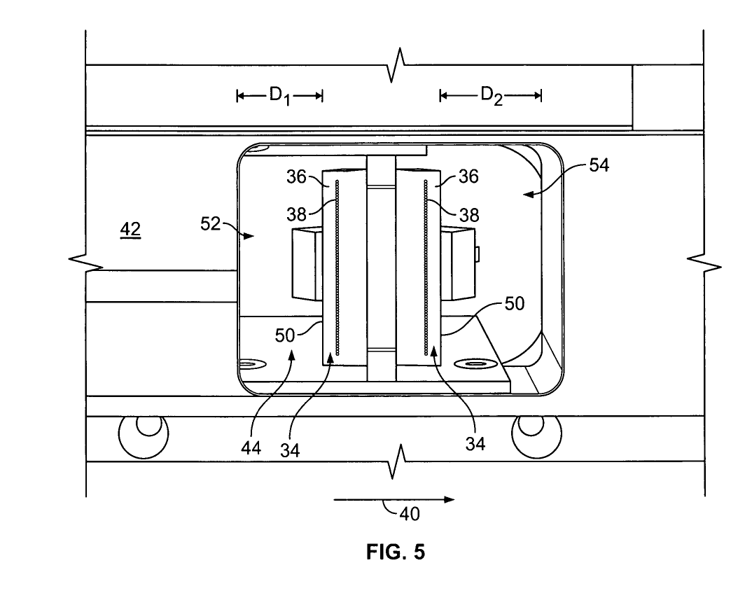

As is shown in greater detail in FIG. 5, each nozzle assembly includes a front face 36 that presents an array of orifices 38. The orifice arrays of the nozzle assemblies 34 extend generally parallel to one another and generally perpendicular to direction in which the articles pass in front of the printhead. This direction, generally illustrated with the arrow 40, is referred to herein as the processing direction. The housing includes a print face or plate 42 which includes a front opening 44. The nozzle assemblies 34 are mounted within the housing such that their front faces align with the front opening 44 so that ink drops expelled from the orifice arrays 38 impact on articles that pass in front of the opening 44.

In prior printhead designs, the housing has generally been constructed to prevent ink, dust and other contaminates from entering the interior compartment of the housing. One reason for sealing the housing was to protect electronics contained within the housing from such contaminants. In such designs, the size of the front opening in the print face has typically been minimized so as to minimize the gap between the print face and the nozzle assemblies. Further, the gap between the print face and the nozzle assemblies has traditionally been sealed, e.g. by an elastomeric gasket.

By contrast, a printhead according to certain aspects of the present invention the front opening 44 functions as an air passage 46 to create positive air flow past the orifice arrays 38. The front air passage 46 surrounding at least a portion orifice arrays 38 to allow air to pass between the exterior and interior of the housing 32. The front air passage 46 is preferably formed by enlarging the front opening such that it extends laterally beyond the side edges 50 of the nozzle assemblies 38. As can be seen in FIG. 5, this results in a first gap or opening 52 on the upstream side of the nozzle assemblies 34 and a second gap 54 on the downstream side of the nozzle assemblies 34. The widths D₁, D₂ of the gaps 52, 54 will depend on the specific printing application and may need to be varied depending on factors such as line speed and throw distance, for example. Moreover, the widths D₁, D₂ need not be the same. Satisfactory results have been achieved with widths ranging from 0.125 inches to 0.5 inches.

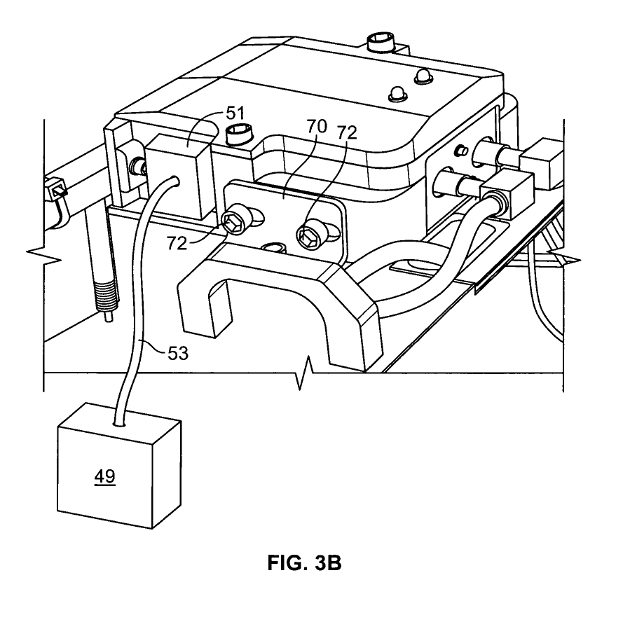

The housing 32 preferably includes at least one additional air passage 48 or opening between exterior and the interior of the housing. In the embodiment shown in FIGS. 2-4 the housing includes air passages 48 in its side walls. The air passages 46, 48 facilitate positive air flow past the orifice arrays 38 to reduce the accumulation of debris around the orifice arrays 38. The printhead 30 could additionally or alternatively be equipped with means such as a fan or vacuum (not shown) to facilitate air flow through the front air passage. As will be appreciated, the vacuum could be used in lieu of the additional air passages. In such a design the vacuum could be connected directly to the front air passage 46 to draw air and contaminants and excess in through the front air passage 44 and away from the orifice array(s) 38. Alternatively, the vacuum could be connected to draw air out of the housing, e.g., through the passages 48, thereby causing air to flow into the housing through the front opening 44. An example of such an arrangement is shown in FIG. 3B, where the vacuum assembly shroud 49 that overlies the side passages 48. The shroud 49 is interconnected to the main vacuum unit 51 via a hose 53. The vacuum unit draws air out of the housing 32 through the openings 48, which in turn causes air to flow into the housing through the front air passage 44.

The printhead 30 may also comprise a means for collecting ink that flows into said housing through said front air passage 44. The means may comprise an absorbent material (not shown) positioned within the housing, adjacent the front passage 44. Alternatively, the means may comprise a vacuum for collecting ink and other contaminants that enter the housing through the front passage.

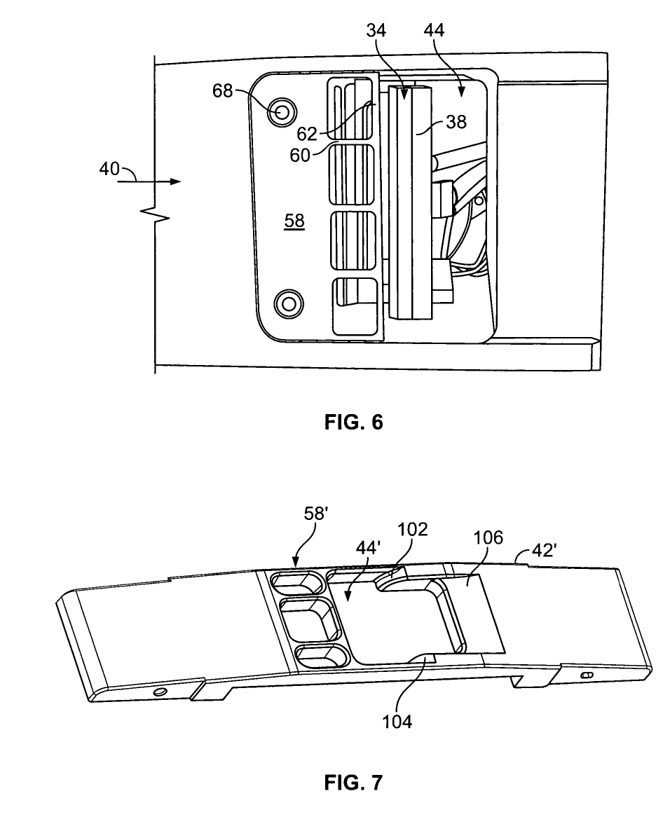

A protective structure 58 may be disposed across a portion of the front passage 46 to prevent the orifice arrays 38 from being damages by materials that pass in front of the array. In the embodiment shown in FIG. 2, the protective structure 58 comprises a grid of horizontal members 60 and vertical members 62 that extend across portions of the passage 46 but which do not interfere with the flow of ink drops from the orifice arrays 38. In the embodiment of FIG. 2, the protective structure comprises an upstream portion 64, positioned upstream of the orifice arrays 38, and a downstream portion 66, positioned downstream of the orifice arrays 38. Alternatively, such structure may only be positioned on one side, e.g., the upstream side of the arrays 38. In the illustrated embodiment, each portion of the protective structure includes one vertical member 62 and one horizontal member 60. It will be appreciated, however, that the protective structure may take numerous other forms without departing from the scope of the present invention. For example, the protective structure 58 may be removably connected to the print plate 42, e.g., by fasteners, as is shown in FIG. 6. The protective structure is particularly beneficial in applications such as mail processing machines where the relatively short distances 0.02 inches or less are common and where mail pieces may contain elements such as paper clips, staples, that could otherwise extend into the front opening as the mail past the printhead 30.

As will be appreciated, the shape and certain other features of the housing will depend on the application for which the printhead is to be used. The embodiment shown in FIGS. 2-4 is configured for use with a mail canceling machine. An example of one such mail canceling machine is described in U.S. Pat. No. 5,988,057, the disclosure of which is hereby incorporated by reference. The housing 32 includes mounting brackets 70 that allow the throw distance to be adjusted, e.g., by loosening fasteners 72 and moving the printhead relative to the brackets 70. The housing 32 also includes an integrally formed horizontal wall 74 that extends outwardly at a location adjacent the bottom edge of the print plate 42. The horizontal wall 74 aligns with a corresponding wall or plate in the print canceling machine to form a continuous surface along which individual pieces of mail travel.

FIG. 7 illustrates an alternative embodiment of a face plate 42′ according to certain aspects of an embodiment of the present invention. The face plate 42′ is configured to be connected to the housing 32 shown in FIG. 2. For this purpose, the bottom of the plate 42′ presents threaded openings 100. Fasteners (not shown) pass through openings in the horizontal wall 72 and thread into the openings to secure the face plate 42′ to the housing 32. The face plate 42′ is similar to the face plate 42 of FIG. 2, except that it only includes protective structure 58′ on the upstream side of the opening 44′. The downstream side of the opening 44′ includes upper and lower walls 102, 104. The upstream ends of the walls are tapered provide a smooth edge, thereby reducing abrasion against packages, e.g., mail, as it passes in front of the opening 44′ during printing. The walls provide support to the mail pieces as the pass in front of the opening to reduce the tendency for the mail pieces to bend inwardly, e.g. bow, into the opening 44′. The face plate further includes a undercut portion 106 located downstream of the opening 44′. The undercut portion 106 is configured to prevent ink smears on the mail pieces as they pass across the face plate after printing. More specifically, the undercut portion provides for a period of downstream non-contact between the face plate and the portion of the mail piece where the printing is deposited by the print head 30.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An inkjet printhead comprising:
a housing having a front face carrying an array of nozzle orifices, the housing including a front opening surrounding the orifice array and at least one other opening, the openings being constructed so as to facilitate air flow past the orifice array to reduce the accumulation of debris around the orifice array.

2. The printhead of claim 1, wherein the housing includes opposed side walls, each of side wall including at least one opening to permit air flow into and out of said housing.

3. The printhead of claim 1, further comprising protective structure disposed across a portion of the front opening to prevent damage to the orifice array.

4. The printhead of claim 3, wherein the orifice array comprises a linear array of orifices and wherein the protective structure comprises a linear member extending across the opening in a direction generally parallel to said orifice array.

5. The printhead of claim 4, wherein the protective structure is located upstream from said orifice array.

6. An ink jet printhead as set forth in claim 3, wherein the protective structure comprises a grid of horizontal and vertical members.

7. A inkjet printhead for use in a printing station of the type having a means for transporting articles through the printing station in a processing direction, the printhead comprising:
a housing having a front face which presents a linear array of nozzles that are oriented in a direction generally transverse to the processing direction, the front face including a front opening surrounding the nozzle array, the opening being constructed to facilitate air flow past the orifice array to reduce the accumulation of debris around the orifice array,
a protective structure extending across at least a portion of the opening to prevent the articles from damaging the opening as they pass in front of the opening.

8. The printhead of claim 7, wherein the protective structure comprises a member extending across the front opening in a direction generally parallel to the orifice array.

9. The printhead of claim 8, wherein the member is positioned upstream of said orifice array.

10. The printhead of claim 7, wherein the protective structure is integrally formed with the front face of the housing.

11. The printhead of claim 7, wherein the protective structure is formed separately front the front face of the housing.

12. An inkjet printhead comprising, comprising:
a housing defining an interior compartment, the housing having a front face which presents an array of nozzles that are adapted to project drops of ink on a substrate as the substrate passes in front of the array, the front face defining a first air passage that surrounds at least a portion of the nozzle array to allow air flow between the exterior of the housing and the interior compartment, the housing defining at least one additional air passage constructed allow air flow between the exterior of the housing and the interior compartment, whereby air flow through the first and at least one additional air passage reduces the accumulation of debris around the nozzle array.

13. The printhead of claim 12, wherein the housing includes opposed side walls, each of said side walls including at least one air passage.

14. The printhead of claim 12, further comprising a protective structure extending across at least a portion of the first air passage to protect the orifice array from being damaged by materials that pass in front of the orifice array during printing.

15. The printhead of claim 17, wherein the orifice array is generally linear and the protective structure comprises a member extending across the first air passage in a direction generally parallel to the orifice array.

16. The printhead of claim 14, wherein the protective structure is positioned upstream of said orifice array.

17. The printhead of claim 14, wherein the protective structure is integrally formed with the front face of the housing.

18. The printhead of claim 14, wherein the protective structure is formed separately front the front face of the housing.
